(19) United States
(12) Patent Application Publication
(10) Pub. No.: US 2006/0119985 A1
(43) Pub. Date: Jun. 8, 2006

(54) Recording medium cartridge and manufacturing method therefor

(75) Inventor: Yoichi Hayashi, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/293,091

(22) Filed: Dec. 5, 2005

(30) Foreign Application Priority Data
Dec. 6, 2004 (JP) 352602/2004

(51) Int. Cl. G11B 23/03

(52) U.S. Cl. 360/133

(57) ABSTRACT

A recording medium cartridge that includes a housing having an access opening that allows access to a recording medium contained in the housing, and a shutter movably attached to the housing to open/close the access opening of the housing. The housing is formed of upper and lower shell halves welded with each other at a plurality of spots on their peripheral walls, and the shutter is formed of upper and lower shell halves fitted with each other at their peripheral walls such that one is nested in the other. The upper and lower shutter halves are welded with each other at least at one spot. In addition, a method for manufacturing such a recording medium cartridge is also provided.

### BACKGROUND OF THE INVENTION

1. Field of the Invention

The present invention relates to a recording medium cartridge that includes a housing having an access opening that allows access to a recording medium contained in the housing, and a shutter movably attached to the housing to open/close the access opening of the housing, in which the housing is formed of upper and lower shell halves welded with each other at the peripheral walls thereof, and the shutter is formed of upper and lower shutter halves fitted with each other at the peripheral walls thereof such that one is nested in the other. The present invention is also directed to a manufacturing method for manufacturing such a recording medium cartridge.

2. Description of the Related Art

In the mobile devices, such as digital cameras and the like, a subminiature recording medium cartridge known as “Click!™” is used as the recording medium as described for example in U.S. Pat. No. 6,133,544.

As shown in FIGS. 5 (perspective view), 6A (plan view), and 6B (bottom view), the aforementioned recording medium cartridge 1 includes a planar housing formed of a resin frame 2 known as a stabilizer having a pressing section 2a for pressing the cartridge with a finger when inserting the cartridge into a drive unit, an upper shell half 3 made of a thin metal plate (stainless steel plate of 0.3 mm thickness) which is fitted to the frame 2 and has a flat main surface, and a lower shell half 4. The size of the housing is 50 mm (W)×55 mm (D) with the thickness of 1.95 mm. The housing movably contains a 40 MB disk-shaped magnetic recording medium 5 of 1.8 inches (45.7 mm) in diameter. A central hub (central core) 10 having a central through-hole is fixedly attached to the central region of the magnetic recording medium 5.

The recording medium cartridge 1 is designed to be loaded in a TYPE II PC card type drive unit (not shown) having outer dimensions of 53 mm (W)×85 mm (D) with the thickness of 5 mm by inserting it into the slot of the drive unit. The housing includes a v-shaped opening 6 that allows a read/write magnetic head of the drive unit to gain access to the surface of the magnetic recording medium 5. A rotary shutter 7 having an opening 7a for rotatingly opening/closing the opening 6 is interposingly provided between the housing and magnetic recording medium 5. The rotary shutter 7 is urged in the closing direction by a coil spring 16, which will be described later with reference to FIG. 9B, and formed such that it is locked at the closing position by a locking member (not shown) attached to the upper shell half 3.

FIGS. 5, 6A and 6B show the rotary shutter 7 in closing state, in which the opening 7a of the rotary shutter 7 is hidden in the housing, and the opening 6 is closed by the rotary shutter 7.

As shown in FIG. 7, which is an enlarged cross-sectional view of the relevant part of the cartridge taken along the line 7-7 in FIG. 6A, the rotary shutter 7 includes an upper shutter half 7U and a lower shutter half 7D, each made of a thin aluminum plate, which are fitted together at the peripheral walls 7Ub, 7Db such that one is nested in the other. The upper shutter half 7U is rotatably supported by a small diameter cylindrical body 3a, which protrudes inwardly from the under surface of the upper shell half 3. A retaining member 11 called central pin is welded at the end of the cylindrical body 3a in order to prevent the upper shutter half 7U from falling out of the cylindrical body 3a, which intrudes in the central through-hole 10a of the central hub 10. A liner 13 made of unwoven cloth with a raised surface for cleaning the surface of the magnetic recording medium 5 is attached to the inner surface of each of the upper and lower shutter halves 7U, 7D.

A round opening 4a is formed in the central region of the lower shell half 4 that allows the central hub 10 to face outside, and a large diameter cylindrical body 7Da protruding downward is provided, which is loosely fitted to the rim of the opening 4a. The lower shutter half 7D is rotatably supported by the lower shell half 4 through the cylindrical body 7Da, and the tip of the cylindrical body 7Da is bent to form a flange 12 for preventing the lower shutter half 7D from falling out of the lower shell half 4.

As is clear from FIG. 6B, the lower shell half 7D has an arc-shaped opening 4b which is formed concentrically with the rotary shutter 7, and a shutter knob 7b, which protrudes from the arc-shaped opening 4b and moves along the arc-shaped opening 4b to open/close the rotary shutter 7, is fixedly attached to the lower shutter half 7D. When the recording medium cartridge 1 is loaded (inserted) in the drive unit, the locking of the rotary shutter 7 by the locking member at the closing position is released and the rotary shutter 7 becomes turnable. At the same time, the engaging wall of the drive unit engages with the shutter knob 7b to rotate the rotary shutter 7 approximately by 60 degrees to the opening position where the opening 7a approximately corresponds to the opening 6 of the upper and lower shell halves 3, 4. In this way, the cartridge 1 is loaded in the drive unit with the magnetic recording medium 5 being exposed from the opening 6 of the housing as shown in FIG. 8A (plan view) and FIG. 8B (bottom view).

In FIG. 7, the magnetic recording medium 5 is brought into contact with the liner 13 of the lower shutter half 7D due to the weight of the central hub 10. When the recording medium cartridge 1 is loaded in the drive unit, however, the central hub 10 is magnetically and mechanically chucked by the drive spindle of the drive unit and the central hub 10 is held up so that the magnetic recording medium 5 is ratatably held at the position which is approximately intermediate of the gap between the surfaces of the upper and lower liners 13.

When the recording medium cartridge 1 loaded in the drive unit is further pushed toward the drive unit, the engagement with the drive unit is released to allow the cartridge to be unloaded. When the recording medium cartridge 1 is unloaded, the rotary shutter 7 is returned to the closing position shown in FIGS. 6A and 6B by the coil spring 16.

As shown at the right edge of the drawing in FIG. 7, the upper and lower shell halves 3, 4 are put together by spot welding with the edges of the peripheral walls 3s, 4s being abutted with each other. The spot welding is performed using a laser beam at 13 welding spots W₁ to W₁₃ along the abutting line as shown in FIG. 6A. The welded spot is indicated by the reference mark W in FIG. 7.

FIG. 9A is an enlarged plan view of the frame, and FIG. 9B is an enlarged plan view of the frame and lower shutter half 7D illustrating the coil spring being mounted between the frame and lower shutter half 7D for urging the rotary shutter 7 in the closing direction.

A guide wire 15 is inserted through the coil spring 16, and both ends of the wire 15 are press fitted respectively in a groove G of a locking section 2b and a groove G of a locking section 2c formed on the frame 2. Dilated sections 15a, 15b are provided at the ends of the wire 15 by flattening the ends in order to prevent the wire 15 from falling out of the grooves G. Each of the dilated sections 15a, 15b has a suitable size that allows the wire 15 to be inserted through the coil spring 16.

The lower shutter half 7D has a radially-outwardly protruding engaging projection 17 for the upper shutter half 7U, which is integrally formed at a place of the peripheral wall 7Db. A cylindrical spring locking section 18 is formed at the tip of the engaging projection 17. The guide wire 15 is inserted through the spring locking section 18 to allow the spring locking section 18 to slide along the guide wire 15. The coil spring 16 is compressedly mounted between a locking wall 2d formed in one of the locking section 2b of the frame 2 and spring locking section 18 to urge the lower shutter half 7D in the closing direction. The other locking section 2c includes a locking wall 2e which is abutted by the spring locking section 18 to hold the lower shutter half 7D at the closing position.

In the mean time, the peripheral wall 7Ub of the upper shutter half 7U is fitted to the peripheral wall 7Db as shown in FIG. 7, and the upper shutter half 7U includes a notch 19 which is fitted to the engaging projection 17 to corotate with the lower shutter half 7D as shown in FIG. 10.

In the conventional recording medium cartridge 1 described above, the upper and lower shutter halves 7U, 7D are configured to coroate by engaging the engaging projection 17 formed integrally with the spring locking section 18 provided in the lower shutter half 7D with the notch 19 formed in the peripheral wall 7Ub of the upper shutter half 7U. This configuration degrades the robustness and accuracy of the shutter. In addition, it has a problem that the upper and lower shutter halves 7U, 7D may be misaligned in up-down directions, since they are merely fitted together at the peripheral walls 7Ub, 7Db.

In view of the circumstances described above, it is an object of the present invention to provide a recording medium cartridge that eliminates the engaging structure for the upper and lower shutter halves in the moving direction to improve the robustness and accuracy of the shutter, as well as preventing misalignment of the shutter halves in up-down directions. It is a further object to provide a manufacturing method for manufacturing such a recording medium cartridge.

### SUMMARY OF THE INVENTION

The recording medium cartridge according to the present invention is a recording medium cartridge, comprising:

a housing having an access opening that allows access to a recording medium contained therein; and

a shutter movably attached to the housing to open/close the access opening of the housing,

wherein:

the housing is formed of upper and lower shell halves welded with each other at a plurality of spots on the peripheral walls thereof, and the shutter is formed of upper and lower shutter halves fitted with each other at the peripheral walls thereof such that one is nested in the other; and

the upper and lower shutter halves are welded with each other at least at one spot.

Preferably, the shutter is a rotary shutter rotatably attached to the inside of the housing.

Further, the upper and lower shutter halves are preferably welded with each other at least at one spot in the fitted section of the peripheral walls.

Still further, the rotary shutter is preferably further rotatable through the opening position in the direction opposite to the closing direction by a predetermined angle of approximately 10 degrees.

Preferably, the upper and lower shutter halves are welded together in the area adjacent to the leading edge of the rotary shutter which is exposed to the access opening of the housing when the rotary shutter is further rotated through the opening position in the direction opposite to the closing direction by the predetermined angle.

Further, the upper and lower shell halves are preferably made of stainless steel, and the upper and lower shutter halves are made of aluminum.

Still further, the recording medium is preferably a rotatable disk having an outer diameter of 1 inch (approximately, 25 mm) or 0.8 inches (approximately, 20 mm) contained in the rotary shutter.

The manufacturing method according to the present invention is a method for manufacturing a recording medium cartridge, comprising the steps of:

forming a housing having an access opening that allows access to a recording medium contained therein by welding upper and lower shell halves with each other at a plurality of spots on the peripheral walls thereof;

forming a rotary shutter rotatably attached to the housing to open/close the access opening of the housing by fitting upper and lower shutter halves with each other at the peripheral walls thereof such that one is nested in the other; and

welding the upper and lower shutter halves with each other at least at one spot in the fitted section of the peripheral walls thereof simultaneously with the welding of the upper and lower shell halves or in a series of welding processes before or after the welding of the upper and lower shell halves.

Preferably, the welding of the upper and lower shell halves is performed by a spot welding process using a laser beam in which edges of the peripheral walls of the upper and lower shell halves are abutted with each other, and the welding is implemented at a plurality of spots along the abutting line.

Further, the welding of the upper and lower shutter halves is preferably performed by a spot welding process using a laser beam.

Still further, the welding of the upper and lower shutter halves is preferably implemented in the area of the upper and lower shutter halves which is hidden inside of the upper and lower shell halves when the shutter is in closing position.

Preferably, the rotary shutter is further rotatable through the opening position in the direction opposite to the closing direction by a predetermined angle of approximately 10 degrees, and the welding of the upper and lower shutter halves is implemented in the area adjacent to the leading edge of the rotary shutter which is exposed to the access opening of the housing when the rotary shutter is further rotated through the opening position in the direction opposite to the closing direction by the predetermined angle.

According to the present invention, the upper and lower shutter halves are welded with each other at least at one spot. This may eliminate the engaging structure for the upper and lower shutter halves in the moving direction. This may not only improve the robustness and accuracy of the shutter but also prevent the misalignment of the upper and lower shutter halves in up-down directions. Further, this may result in more space available in the housing.

Further, the welding of the upper and lower shutter halves is performed simultaneously with the welding of the upper and lower shell halves or in a series of welding processes before or after the welding of the upper and lower shell halves, so that the welding of the upper and lower shutter halves may be implemented without any appreciable cost increase.

Still further, the welding of the upper and lower shutter halves is implemented in the area of the upper and lower shutter halves which is hidden inside of the upper and lower shell halves when the shutter is in closing position, so that degradation of the appearance of the cartridge due to the welding of the upper and lower shutter halves may be avoided.

### BRIEF DESCRIPTION OF THE DRAWINGS

FIG. 1A is a plan view of a recording medium cartridge according to the present invention.

FIG. 1B is a bottom view of the recording medium cartridge according to the present invention.

FIG. 2 is an enlarged cross-sectional view of the relevant part of the cartridge shown in FIG. 1.

FIG. 3 is a front view of a holding rod used when the upper and lower shell halves are welded.

FIG. 4A is a plan view of the recording medium cartridge according to the present invention, illustrating the location of the upper and lower shutter halves when they are welded with each other.

FIG. 4B is a bottom view of the recording medium cartridge according to the present invention, illustrating the location of the upper and lower shutter halves when they are welded with each other.

FIG. 5 is a perspective view of a conventional recording medium cartridge to which the present invention is applied.

FIG. 6A is a plan view of the recording medium cartridge shown in FIG. 5, illustrating the rotary shutter thereof is in closing position.

FIG. 6B is a bottom view of the recording medium cartridge shown in FIG. 5, illustrating the rotary shutter thereof is in closing position.

FIG. 7 is an enlarged cross-sectional view of the relevant part of the recording medium cartridge taken along the line 7-7 in FIG. 6A.

FIG. 8A is a plan view of the recording medium cartridge shown in FIG. 5, illustrating the rotary shutter thereof is in opening position.

FIG. 8B is a bottom view of the recording medium cartridge shown in FIG. 5, illustrating the rotary shutter thereof is in opening position.

FIG. 9A is an enlarged plan view of the frame of the recording medium cartridge shown in FIG. 5.

FIG. 9B is an enlarged plan view of the frame and lower shutter half, illustrating a coil spring being mounted between the frame and lower shutter half for urging the rotary shutter in the closing direction.

FIG. 10 is an enlarged perspective view of the recording medium cartridge shown in FIG. 5, illustrating an engaging structure for the upper and lower shutter halves.

### DESCRIPTION OF THE PREFERRED EMBODIMENTS

Hereinafter, an illustrative embodiment of the present invention will be described in detail with reference to the accompanying drawings.

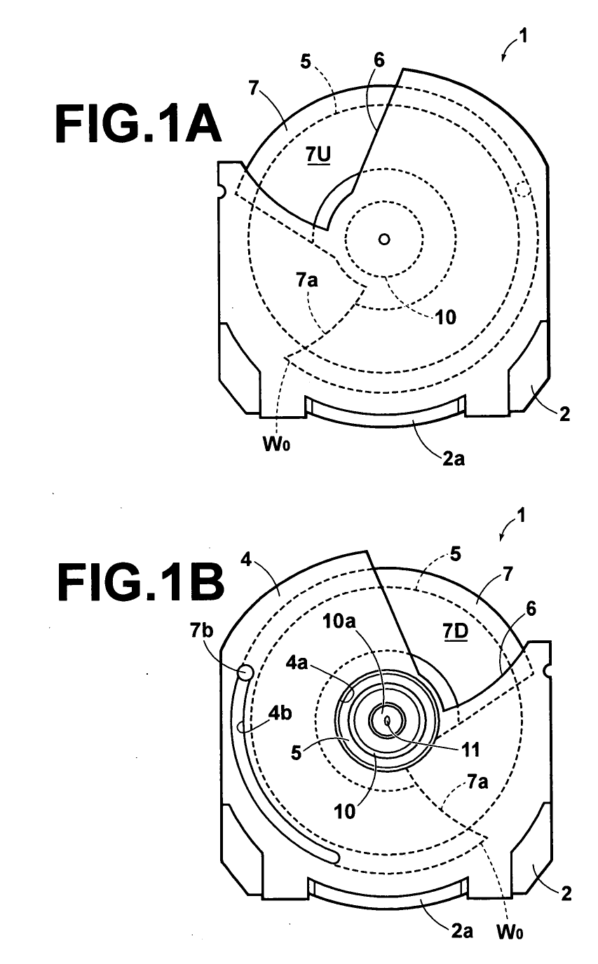

FIG. 1A is a plan view and FIG. 1B is a bottom view of a recording medium cartridge according to the present invention.

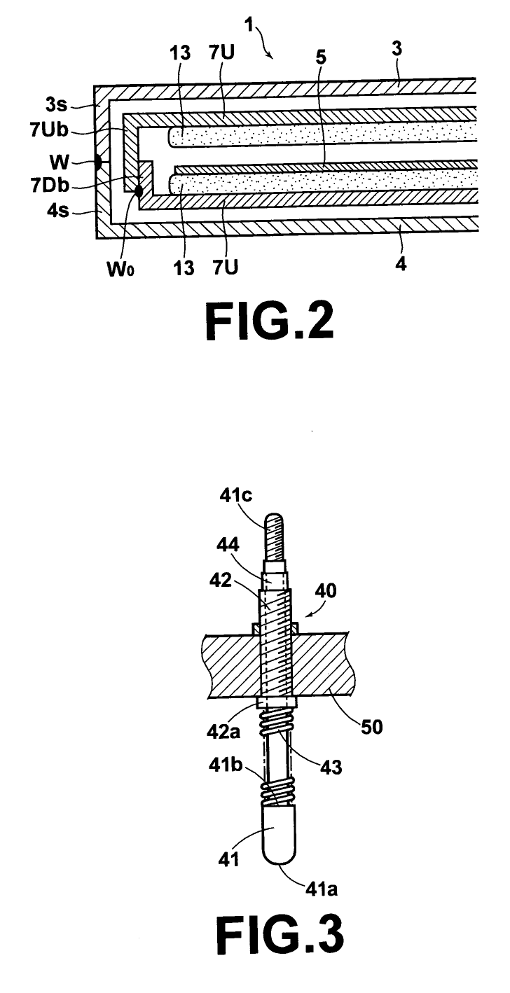

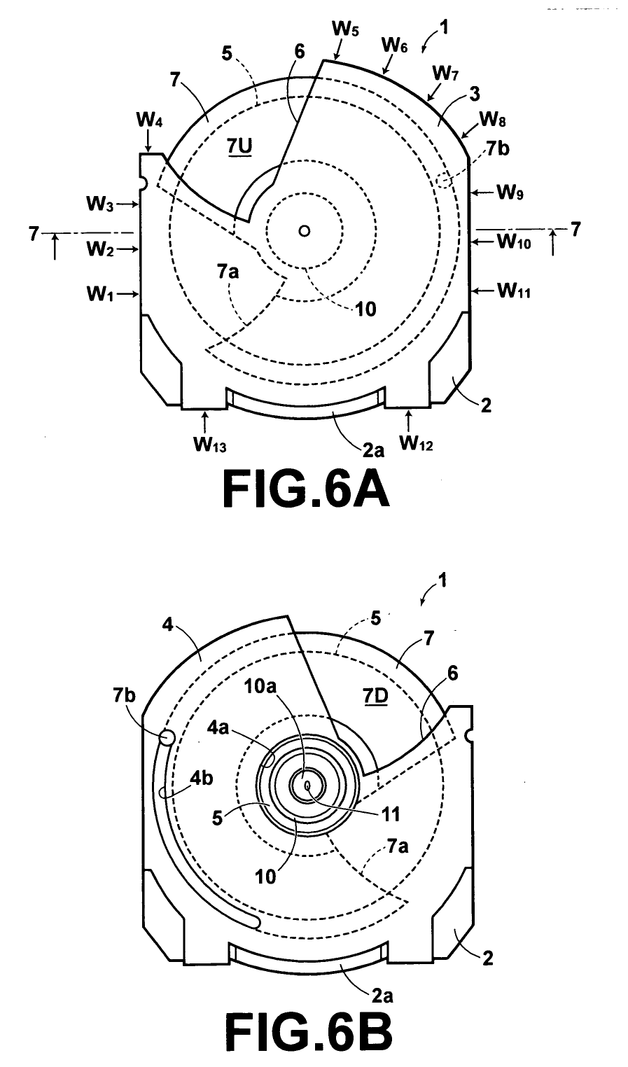

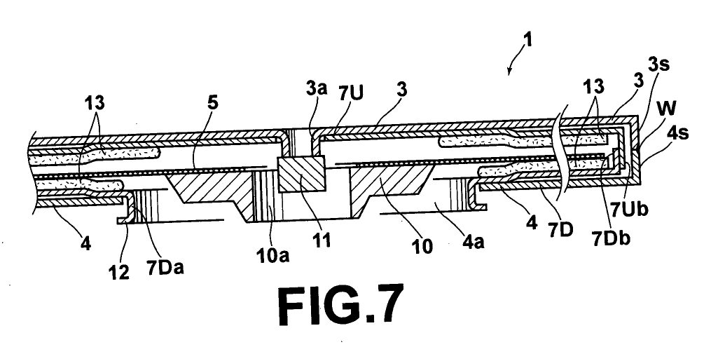

FIG. 2 is an enlarged cross-sectional view of the relevant part of the cartridge shown in FIG. 1. The recording medium cartridge shown in FIGS. 1A, 1B and 2 has no engaging structure in the fitted section of the peripheral walls 7Ub, 7Db of the upper and lower shutter halves 7U, 7D for the upper and lower shutter halves in the rotational direction. It has a substantially identical structure to that of the recording medium cartridge already described with reference to FIGS. 6A, 6B and 7, other than that the upper and lower shutter halves are welded with each other at least at one spot W₀. Therefore, the identical members are given the same reference numerals and will not be elaborated upon further here.

If the welding spot W₀ of the peripheral walls 7Ub, 7Db of the upper and lower shutter halves 7U, 7D is set in an area which is exposed from the opening 6 of the housing when the rotary shutter 7 is in closing position, the welding may be implemented easily, but it may degrade the appearance of the cartridge due to the welded spot. Consequently, in the present embodiment, the welding spot W₀ is set in an area which is hidden inside of the housing when the rotary shutter is in closing position as shown in FIGS. 1A and 1B.

When performing spot welding using a laser beam at 13 spots W₁ to W₁₃ shown in FIG. 6A in the abutting section of the peripheral walls 3s, 4s of the upper and lower shell halves 3, 4, the welding is performed with the upper shell half 3 of the housing fixed on a movable platform (not shown) being pressed from above in the vicinity of each of the 13 welding spots W₁ to W₁₃ around the periphery of the main surface thereof using 13 holding rods 40 mounted in a rod holding member 50 as shown in FIG. 3.

Each of the holding rods 40 shown in FIG. 3 includes a rod body 41 having a hemispherical lower end face 41a that touches the upper shell half 3 in the vicinity of each of the 13 welding spots W₁ to W₁₃ around the periphery of the main surface thereof, an outer casing 42 through which the rod body 41 is slidably mounted in up-down directions and has a thread groove on the outer circumference to be adjustably mounted in up-down directions in the rod holding member 50, a shoulder formed at the rod body 41b, a coil spring 43 compressedly mounted between the shoulder 41b and a flange 42a of the outer casing 42, and an adjusting nut 44 sprirally mounted on the upper end section 41c of the rod body 41 for adjusting the spring pressure of the coil spring 43.

The 13 holding rods 40 constructed in the manner as described above are mounted in the rod holding member 50, so that the position of the lower end face 41a of each of the rod bodies 41 relative to the periphery of the main surface of the upper shell half 3 and the contact pressure thereof may be adjusted on a rod by rod basis.

The welding at the 13 spots W₁ to W₁₃ in the abutting section of the peripheral walls 3s, 4s of the upper and lower shell halves 3, 4 and at one welding spot W₀ on the peripheral walls 7Ub, 7Db of the upper and lower shutter halves 7U, 7D may be performed simultaneously or sequentially. But the sequential welding, in which the welding is performed one spot after another, is more advantageous in that it may be performed with a simpler optics system for irradiating the laser beam. In this case, work is fixed on a rotating platform which is movable relative to the optics system and the welding may be performed at each of the welding spots.

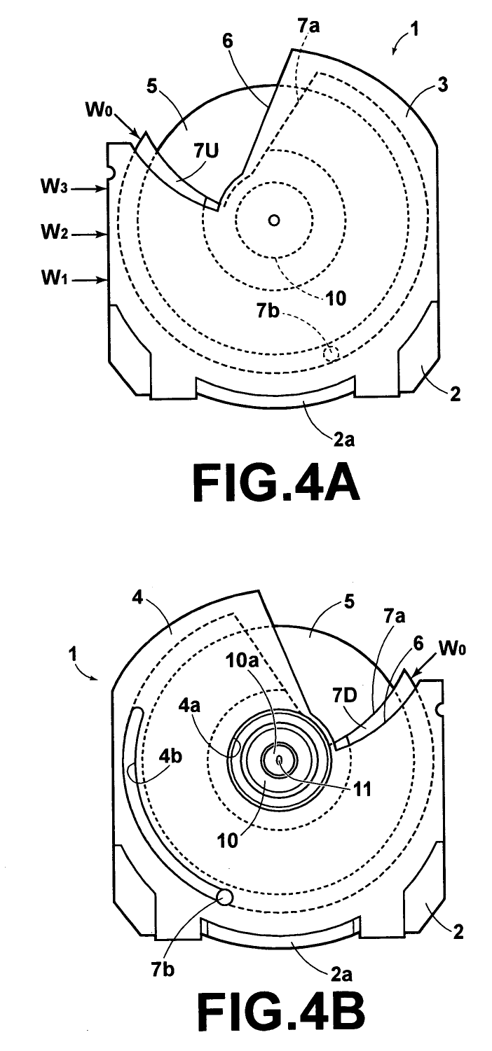

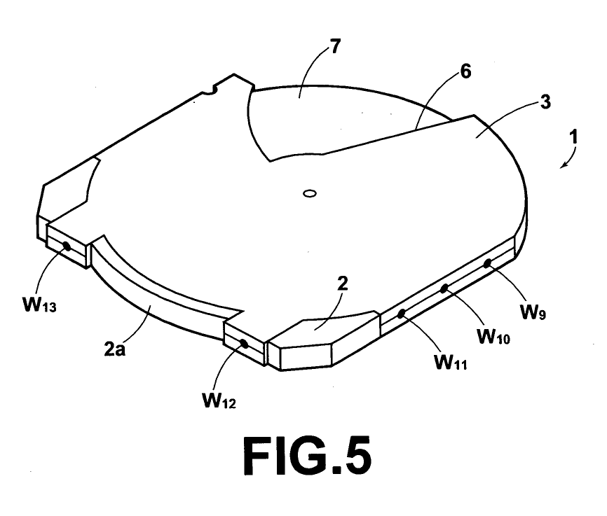

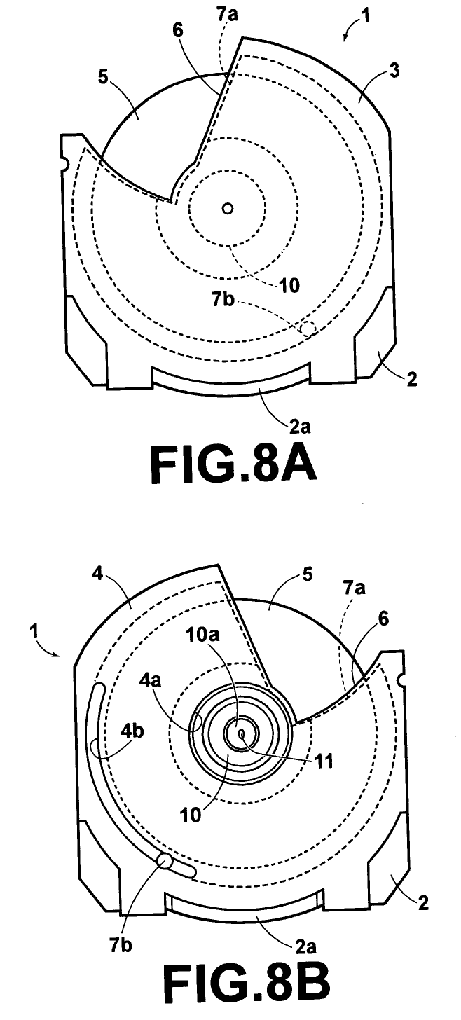

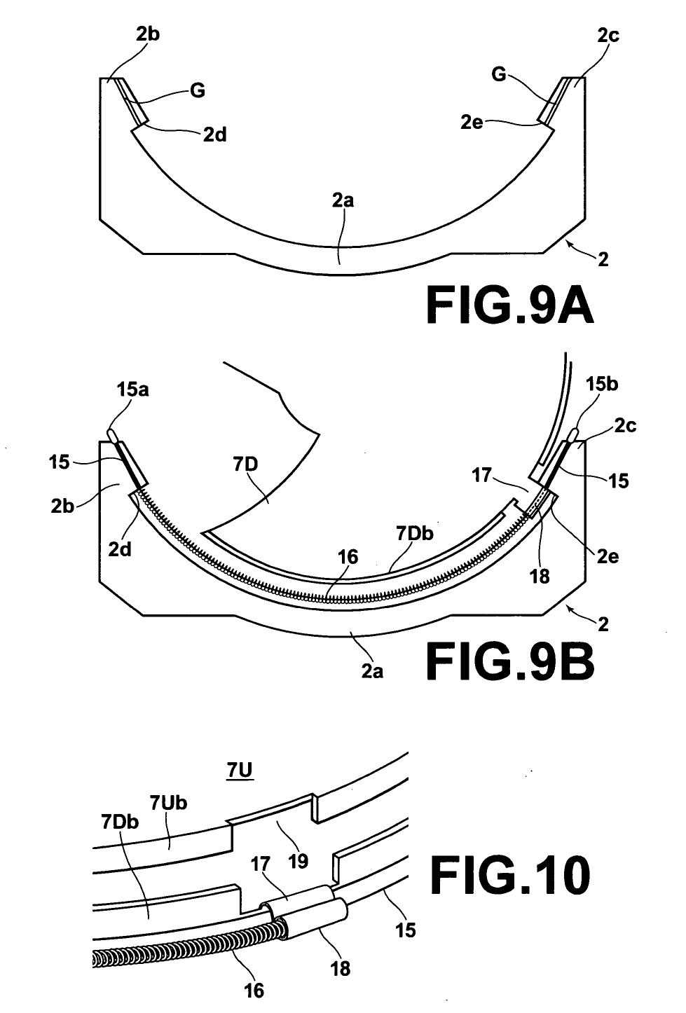

When performing the welding of the peripheral walls 7Ub, 7Db of the upper and lower shutter halves 7U, 7D, the relative positions between the shutter knob 7b and arc-shaped opening 4b may be preset such that the rotary shutter may further turn in the clockwise direction in FIG. 8A (counterclockwise direction in FIG. 8B) through the opening position shown in FIGS. 8A and 8B by a predetermined angle (around 10 degrees) if required. Then, the upper and lower shutter halves 7U, 7D fitted with each other at their peripheral walls 7Ub, 7Db are turned from the closing position shown in FIGS. 6A and 6B to the position shown in FIGS. 4A and 4B through the opening position shown in FIGS. 8A and 8B to expose the area adjacent to the leading edge of the opening 7a in the rotational direction to the opening 6 of the housing. In this way, the welding may be performed in the area of the peripheral walls of the upper and lower shutter halves 7U, 7D which is exposed to the opening 6 of the housing. By doing so, the welded spot W₀ may be hidden inside of the housing when the shutter 7 is in closing position. This may prevent degradation of the appearance due to exposure of the welded spot W₀.

In the mean time, a small gap is present at the abutting section of the peripheral walls 3s, 4s. This may cause a problem that the weld slag of a metal melted at the welding and the like enter through the gap and contaminate the magnetic recording medium. In this case, of the 13 welding spots W₁ to W₁₃ of the upper and lower shell halves 3, 4 shown in FIG. 6a, the welding spots W₄ to W₁₃ locate where the peripheral walls 7Ub, 7Db of the upper and lower shutter halves 7U, 7D are overlappingly fitted with each other as is clear from FIGS. 2 and 7. Consequently, the peripheral walls 7Ub, 7Db of the upper and lower shutter halves 7U, 7D may serve as a shield and the magnetic recording medium 5 is protected from the weld slag and the like when the welding at these spots is implemented. On the other hand, when the rotary shutter 7 is in closing position, the opening 7a thereof locates opposite to the welding spots W₁ to W₃ as is clear from FIG. 6A. If welding is performed at the welding spots W₁ to W₃ under this condition, the magnetic recording medium 5 may be contaminated.

Accordingly, if the welding at the welding spot W₀ on the peripheral walls 7Ub, 7Db of the upper and lower shutter halves 7U, 7D and at the welding spots W₁ to W₃ is performed after the rotary shutter 7 is turned to the position shown in FIGS. 4A and 4B, the contamination problem of the magnetic recording medium may be avoided.

In the present embodiment, the upper and lower shell halves 3, 4 are made of stainless steel plates, and the upper and lower shutter halves 7U, 7D are made of thin aluminum plates. This may require a slight change in the welding conditions between them, but the upper and lower shutter halves 7U, 7D may be welded without any appreciable const increase by performing the welding of the upper and lower shell halves 3, 4, and the upper and lower shutter halves 7U, 7D in a series of welding processes using the same welding unit.

The welding of the upper and lower shutter halves 7U, 7D at least at one spot may eliminate the engaging structure for the upper and lower shutter halves in the moving direction. This may not only improve the robustness and accuracy of the shutter 7 but also prevent the misalignment of the upper and lower shutter halves in up-down directions. Further, this may result in more space available in the housing.

The present embodiment described above is an illustrative example of “Click!” which has a magnetic recording medium 5 with the external diameter of 1.8 inches (approximately 46 mm). But the present invention is not limited to the specific embodiment as illustrated herein. For example, the present invention is applicable to cartridges having ultracompact high density recording media including smaller and high density medium of 1 inch (approximately 25 mm) and of 0.8 inches (approximately 20 mm) to be developed in the future. Further, the recording medium is not limited to a disk, and it may be a tape, hard disk, optical medium, semiconductor, and the like.

In the illustrative embodiment described above, the rotary shutter 7 is built in the housing. It is obvious that the present invention may also be applied to a recording medium cartridge having an externally provided rotary or sliding shutter.

What is claimed is:

1. A recording medium cartridge, comprising:
a housing having an access opening that allows access to a recording medium contained therein; and
a shutter movably attached to the housing to open/close the access opening of the housing,
wherein:
the housing is formed of upper and lower shell halves welded with each other at a plurality of spots on the peripheral walls thereof, and the shutter is formed of upper and lower shutter halves fitted with each other at the peripheral walls thereof such that one is nested in the other; and
the upper and lower shutter halves are welded with each other at least at one spot.

2. The recording medium cartridge according to claim 1, wherein the shutter is a rotary shutter rotatably attached to the inside of the housing.

3. The recording medium cartridge according to claim 2, wherein the upper and lower shutter halves are welded with each other at least at one spot in the fitted section of the peripheral walls.

4. The recording medium cartridge according to claim 3, wherein the rotary shutter is further rotatable through the opening position in the direction opposite to the closing direction by a predetermined angle.

5. The recording medium cartridge according to claim 4, wherein the upper and lower shutter halves are welded together in the area adjacent to the leading edge of the rotary shutter which is exposed to the access opening of the housing when the rotary shutter is further rotated through the opening position in the direction opposite to the closing direction by the predetermined angle.

6. The recording medium cartridge according to claim 4, wherein the predetermined angle is approximately 10 degrees.

7. The recording medium cartridge according to claim 1, wherein the upper and lower shell halves are made of stainless steel, and the upper and lower shutter halves are made of aluminum.

8. The recording medium cartridge according to claim 2, wherein the recording medium is a rotatable disk having an outer diameter of 1 inch (approximately, 25 mm) contained in the rotary shutter.

9. The recording medium cartridge according to claim 2, wherein the recording medium is a rotatable disk having an outer diameter of 0.8 inches (approximately, 20 mm) contained in the rotary shutter.

10. A manufacturing method for manufacturing a recording medium cartridge, comprising the steps of:
forming a housing having an access opening that allows access to a recording medium contained therein by welding upper and lower shell halves with each other at a plurality of spots on the peripheral walls thereof;
forming a rotary shutter rotatably attached to the housing to open/close the access opening of the housing by fitting upper and lower shutter halves with each other at the peripheral walls thereof such that one is nested in the other; and
welding the upper and lower shutter halves with each other at least at one spot in the fitted section of the peripheral walls thereof simultaneously with the welding of the upper and lower shell halves or in a series of welding processes before or after the welding of the upper and lower shell halves.

11. The manufacturing method according to claim 10, wherein the welding of the upper and lower shell halves is performed by a spot welding process using a laser beam in which edges of the peripheral walls of the upper and lower shell halves are abutted with each other, and the welding is implemented at a plurality of spots along the abutting line.

12. The manufacturing method according to claim 11, wherein the welding of the upper and lower shutter halves is performed by a spot welding process using a laser beam.

13. The manufacturing method according to claim 10, wherein the welding of the upper and lower shutter halves is implemented in the area of the upper and lower shutter halves which is hidden inside of the upper and lower shell halves when the shutter is in closing position.

14. The manufacturing method according to claim 13, wherein the rotary shutter is further rotatable through the opening position in the direction opposite to the closing direction by a predetermined angle.

15. The manufacturing method according to claim 14, wherein the welding of the upper and lower shutter halves is implemented in the area adjacent to the leading edge of the rotary shutter which is exposed to the access opening of the housing when the rotary shutter is further rotated through the opening position in the direction opposite to the closing direction by the predetermined angle.

16. The manufacturing method according to claim 14, wherein the predetermined angle is approximately 10 degrees.

17. The manufacturing method according to claim 10, wherein the upper and lower shell halves are made of stainless steel, and the upper and lower shutter halves are made of aluminum.

18. The manufacturing method according to claim 10, wherein the recording medium is a rotatable disk having an outer diameter of 1 inch (approximately, 25 mm) contained in the rotary shutter.

19. The manufacturing method according to claim 10, wherein the recording medium is a rotatable disk having an outer diameter of 0.8 inches (approximately, 20 mm) contained in the rotary shutter.
